(19) United States
(12) Patent Application Publication
(10) Pub. No.: US 2013/0025637 A1
(43) Pub. Date: Jan. 31, 2013

(54) SIPHON BREAK APPARATUS CONFIGURED TO PREVENT A SIPHON EFFECT IN A FLUID CONDUIT OF A DISHWASHER AND AN ASSOCIATED METHOD

(71) Applicants: Virgil J. Francisco, Ayden, NC (US); Jason M. Patterson, Kinston, NC (US); Billy Justin Hill, Kinston, NC (US); Mark D. Montgomery, Greenville, NC (US); James L. Burrows, Winterville, NC (US)

(72) Inventors: Virgil J. Francisco, Ayden, NC (US); Jason M. Patterson, Kinston, NC (US); Billy Justin Hill, Kinston, NC (US); Mark D. Montgomery, Greenville, NC (US); James L. Burrows, Winterville, NC (US)

(73) Assignee: ELECTROLUX HOME PRODUCTS, INC., Cleveland, OH (US)

(21) Appl. No.: 13/192,926

(22) Filed: Jul. 28, 2011

(51) Int. Cl. A47L 15/42; B01D 35/02; B23P 11/00; B01D 35/14

(52) U.S. Cl. 134/110; 210/136; 29/428

(57) ABSTRACT

According to exemplary embodiments, a dishwasher or other washing appliance includes a siphon break apparatus configured to substantially prevent a siphon effect in a fluid conduit configured to drain fluid from the dishwasher or other washing appliance. The siphon break apparatus may include a body portion that may be divided by a filter into a filter chamber and a flow chamber. The filter chamber may extend perpendicularly from the flow chamber. An aperture may be defined in the filter chamber and sealed shut by a domed closure of a normally-closed umbrella valve. The domed closure may unseal from the aperture and thereby allow air to enter the filter chamber, travel through the filter and into the flow chamber so as to relieve a low pressure region and substantially prevent a siphon effect in the fluid conduit. A related method is also provided.

### BACKGROUND

1. Field of the Disclosure

Embodiments of the disclosure are generally directed to siphon prevention apparatuses and, more particularly, to a siphon break apparatus configured to substantially prevent a siphon effect in a fluid conduit configured to drain a fluid from a dishwasher.

2. Description of Related Art

One issue of interest in the field of dishwashers is to allow for proper draining of fluids from the dishwasher. In this regard, during a drain cycle it may be desirable to pump out soiled water from the dishwasher that may include water, detergent, and food matter removed from the dishes. Thus, the dishwasher may include a drain pump that expels the soiled water from the washing chamber through a drain hose. The drain hose may be routed so that the soiled water first travels upwardly and then downwardly out of the dishwasher towards drain plumbing to resist backflow of water into the dishwasher from the plumbing and sewage system connected thereto.

However, as a result of this configuration of the drain hose, a siphon effect may occur. The siphon effect may act by way of atmospheric pressure pushing water up the drain hose into a reduced pressure region at the top of the drain hose. The reduced pressure region is caused by water falling on the exit side of the drain hose leading to the plumbing. The siphon effect may thus cause the undesirable result that water is pulled from the washing cavity through the drain pump and out the drain hose after the drain pump has stopped operating. Thereby, water with a lower soil content that is intended to remain in the washing chamber and needed to further wash or rinse the dishes may instead be pulled out of the washing chamber by the siphon effect. Conversely, if a check valve is not operating properly or is not provided, the siphon effect may pull soiled water into the washing chamber from the plumbing side of the drain hose in some instances, which may also be undesirable.

Techniques have been developed to address the siphon effect. For example, a vent hose and a check valve may be employed and/or the drain hose may vent through a sink drain. Accordingly, the siphon effect may not occur because pressure in the drain hose may be relieved by the vent, and water may no longer be drawn out of or into the washing chamber. Check valves may function by opening to allow air to enter the drain hose while substantially preventing water from escaping through the vent hose. However, these solutions may not function properly in some instances. For example, the drain hose or vent hose may be improperly installed, and check valves may leak. Thus, the siphon effect described above may still occur with present dishwasher configurations.

### BRIEF SUMMARY

In one embodiment a siphon break apparatus configured to substantially prevent a siphon effect in a fluid conduit is provided. The siphon break apparatus may comprise a body portion configured to connect to the fluid conduit. The body portion may define an internal cavity and an aperture configured to selectively provide fluid communication between the internal cavity and an external environment. Further, the siphon break apparatus may include a filter coupled to the body portion so as to define a filter chamber in the internal cavity, the aperture configured to selectively provide for fluid communication with the filter chamber. Also, the siphon break apparatus may include an umbrella valve connected to the body portion and at least partially received in the filter chamber. The umbrella valve may comprise a domed closure configurable between a first position wherein the domed closure substantially seals the aperture closed and a second position wherein the domed closure at least partially unseals the aperture so as to provide fluid communication between the internal cavity and the external environment and thereby substantially prevents the siphon effect in the fluid conduit.

In some embodiments the filter may be configured to divide the internal cavity into the filter chamber and a flow chamber, and the flow chamber may be configured to receive a fluid flowing through the fluid conduit. The umbrella valve further may comprise a stem, wherein the stem extends from the filter chamber to the external environment. Additionally, the filter may define a filter surface, and the filter surface may be oriented substantially perpendicularly to a major axis of the flow chamber such that fluid flow through the flow chamber is tangential to the filter surface. Further, the filter may define a plurality of orifices that extend substantially perpendicularly to a major axis of the flow chamber.

In some embodiments the body portion may define an inlet and an outlet, and the inlet, the flow chamber, and outlet may be disposed coaxially to one another. Also, the filter may comprise a plurality of orifices defining a filter area, the flow chamber may define a cross-sectional area substantially perpendicular to a major axis of the flow chamber, and the filter area may be less than the cross-sectional area of the flow chamber. Further, the domed closure may be biased to the first position such that the domed closure is initially closed when fluid flows through the flow chamber. Additionally, the aperture may be spaced away from the filter and the flow chamber. The umbrella valve may be configured to unseal from the aperture in the second position and allow air from the external environment to enter the filter chamber, travel through the filter and into the flow chamber so as to relieve a low pressure region and substantially prevent the siphon effect in the fluid conduit.

In some embodiments the filter chamber may extend perpendicularly from the flow chamber. The body portion may be T-shaped, and the filter chamber may be positioned above the flow chamber in some embodiments. The filter chamber may define a curved configuration. For example, the flow chamber may define an inverted U-shape. The umbrella valve may further comprise a stem, wherein the stem extends from the filter chamber to the external environment. Additionally, the body portion may comprise a filter chamber cap at least partially defining the filter chamber. The aperture may be defined in the filter chamber cap. Further, the filter chamber cap may be removable or permanently attached to the body portion. In some embodiments the domed closure may be configured to remain inside the filter chamber in both the first position and the second position.

In an additional embodiment a dishwasher is provided. The dishwasher may comprise a washing chamber, a fluid supply configured to supply a fluid to the washing chamber, a drain pump configured to pump the fluid through a fluid conduit configured to drain the fluid from the washing chamber, and a siphon break apparatus coupled to the fluid conduit and configured to substantially prevent a siphon effect in the fluid conduit. The siphon break apparatus may comprise a body portion configured to connect to the fluid conduit. The body portion may define an internal cavity and an aperture configured to selectively provide fluid communication between the internal cavity and an external environment. The siphon break apparatus may further include a filter coupled to the body portion so as to define a filter chamber in the internal cavity, the aperture configured to selectively provide for fluid communication with the filter chamber. Also, the siphon break apparatus may include an umbrella valve connected to the body portion and at least partially received in the filter chamber. The umbrella valve may comprise a domed closure configurable between a first position wherein the domed closure substantially seals the aperture closed, and a second position wherein the domed closure at least partially unseals the aperture so as to provide fluid communication between the internal cavity and the external environment and thereby substantially prevents the siphon effect in the fluid conduit.

In some embodiments the filter may be configured to divide the internal cavity into the filter chamber and a flow chamber, and the flow chamber may be configured to receive a fluid flowing through the fluid conduit. Further, the body portion may be configured such that a major axis of the flow chamber is oriented substantially horizontally, substantially vertically, or in other positions in some embodiments. Also, the filter chamber may be positioned above the flow chamber.

In a further embodiment a method for assembling a dishwasher is provided. The method may comprise the steps of providing a dishwasher comprising a washing chamber, a fluid supply configured to supply a fluid to the washing chamber, and a drain pump configured to receive the fluid and pump the fluid through a fluid conduit configured to drain the fluid from the washing chamber. Further the method may include coupling a siphon break apparatus to the fluid conduit, wherein the siphon break is configured to substantially prevent a siphon effect in the fluid conduit. The siphon break apparatus may comprise a body portion configured to connect to the fluid conduit. The body portion may define an internal cavity and an aperture configured to selectively provide fluid communication between the internal cavity and an external environment. Further, the siphon break apparatus may include a filter coupled to the body portion so as to define a filter chamber in the internal cavity. The aperture may be configured to selectively provide for fluid communication with the filter chamber. Additionally, the siphon break apparatus may include an umbrella valve connected to the body portion and at least partially received in the filter chamber. The umbrella valve may comprise a domed closure configurable between a first position wherein the domed closure substantially seals the aperture closed and a second position wherein the domed closure at least partially unseals the aperture so as to provide fluid communication between the internal cavity and the external environment and thereby substantially prevents the siphon effect in the fluid conduit.

In some embodiments the filter is configured to divide the internal cavity into the filter chamber and a flow chamber, and the flow chamber may be configured to receive a fluid flowing through the fluid conduit. Thus, the method may further comprise the step of positioning the body portion such that a major axis of the flow chamber is oriented substantially horizontally, substantially vertically, or in other positions. Further, the method may include the step of positioning the body portion such that the filter chamber is positioned above the flow chamber in some embodiments.

As such, aspects of the present disclosure may provide significant advantages as otherwise detailed herein.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 illustrates one embodiment of a dishwasher comprising a drain hose;

FIG. 2 illustrates a schematic view of a siphon break apparatus coupled to the drain hose of FIG. 1 in a horizontal configuration according to an exemplary embodiment;

FIG. 3 illustrates a sectional view through the siphon break apparatus of FIG. 2 when an umbrella valve of the siphon break apparatus is closed according to an exemplary embodiment;

FIG. 4 illustrates an enlarged sectional view of the siphon break apparatus of FIG. 3 when the umbrella valve of the siphon break apparatus is open according to an exemplary embodiment;

FIG. 5 illustrates a schematic view of the siphon break apparatus and drain hose of FIG. 2 in a vertical configuration according to an exemplary embodiment; and

FIG. 6 illustrates a method for assembling a dishwasher according to an exemplary embodiment.

### DETAILED DESCRIPTION

The present disclosure now will be described more fully hereinafter with reference to the accompanying drawings, in which some, but not all embodiments are shown. Indeed, embodiments may define many different forms and should not be construed as limited to the embodiments set forth herein; rather, these embodiments are provided so that this disclosure will satisfy applicable legal requirements. Like numbers refer to like elements throughout.

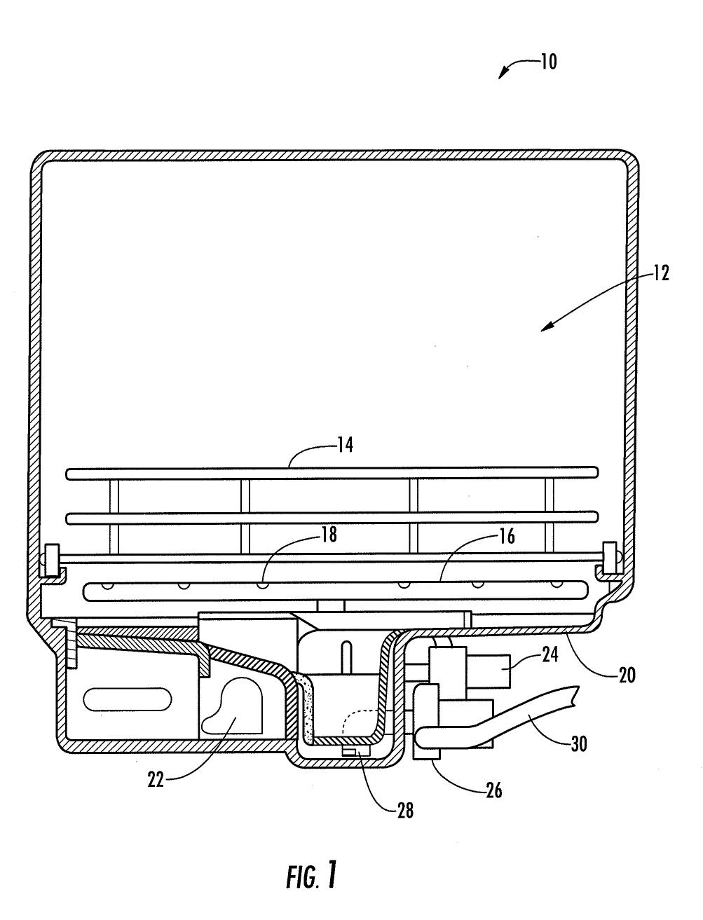

FIG. 1 shows an exemplary embodiment of a dishwasher 10. The dishwasher 10 may comprise a washing chamber 12 in which dishware may be inserted in a dish rack 14. In the washing chamber 12 there may be one or more rotating spray arms 16 that direct circulating dishwashing fluid through spray nozzles 18 towards the dishware that is placed in the dish rack 14. The circulating dishwashing fluid may fall down on a bottom wall 20 of the washing chamber 12 and be directed towards an inlet 22 for a circulation pump 24 for redistribution of the dishwashing fluid to the rotating spray arm 16.

When a washing cycle is complete, the dishwasher 10 may dispose of the soiled water. In this regard, the dishwasher 10 may further comprise a drain pump 26 that is configured to pull the soiled water from the washing chamber 12 through an inlet 28 and discharge the soiled water through a fluid conduit such as the illustrated drain hose 30. The drain hose 30 may lead to plumbing within a home or other structure in which the dishwasher 10 is installed. Accordingly, dishware may be cleaned and the resulting soiled water may be disposed of through a sewage system.

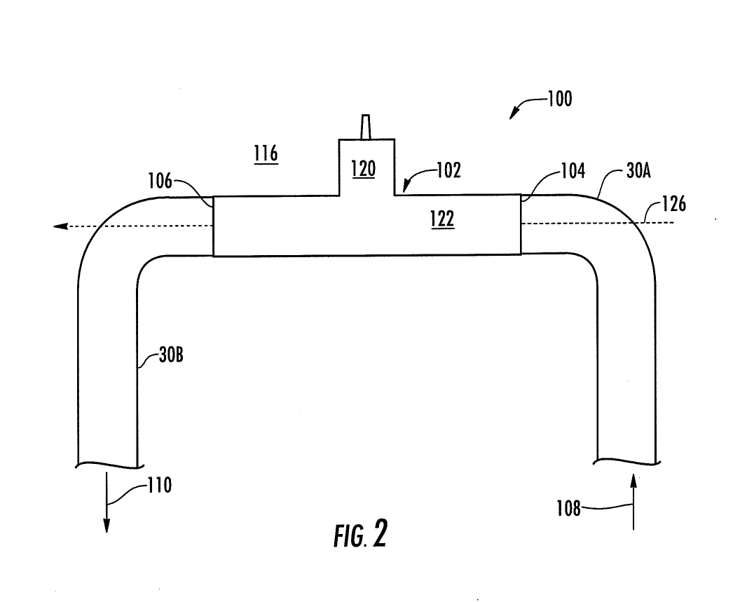

In some embodiments the drain hose 30 may be configured to slope upwardly and then downwardly before connecting to the plumbing so as to resist backflow of soiled water from the plumbing into the dishwasher 10. This configuration may have the undesirable result of producing a siphon effect that may uncontrollably draw water out of the washing chamber 12 or, under unusual circumstances, draw soiled water back into the dishwasher 10. Accordingly, FIGS. 2-5 illustrate an embodiment of a siphon break apparatus 100 that may be configured to substantially prevent the siphon effect in the drain hose 30 of the dishwasher 10 illustrated in FIG. 1, or in various other embodiments of fluid conduits in dishwashers and other washing appliances.

In this regard, FIG. 2 illustrates an embodiment of the siphon break apparatus 100 connected to the drain hose 30. The siphon break apparatus 100 may comprise a body portion 102 that is configured to connect to the drain hose 30 or other fluid conduit. The body portion 102 may define an inlet 104 and an outlet 106 which may respectfully connect to first 30A and second 30B portions of the drain hose 30. Accordingly, the first portion 30A of the drain hose 30 may connect to the dishwasher 10, and the second portion 30B of the drain hose may connect to a sewage line in some embodiments. Accordingly, fluid exiting the dishwasher 10 may be directed into the first portion 30A of the drain hose 30 (as indicated by arrow 108), through the body portion 102 of the siphon break apparatus 100, then out through the second portion 30B of the drain hose (as indicated by arrow 110).

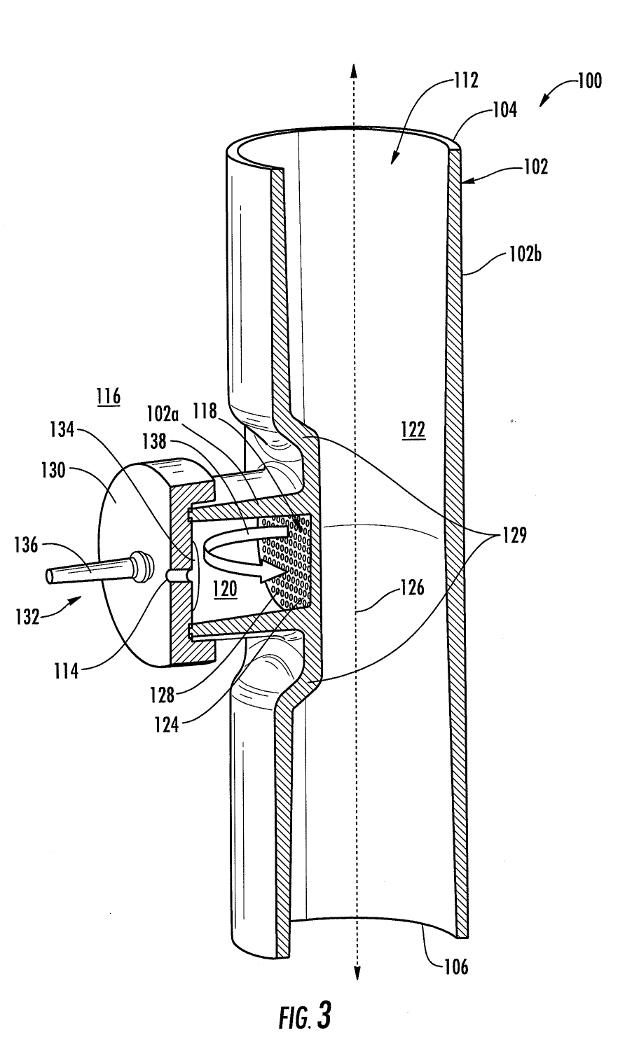

FIG. 3 illustrates a sectional view through the siphon break apparatus 100. As illustrated, the body portion 102 may define an internal cavity 112 configured to receive a fluid drained through the drain hose 30, as discussed above. Further, the body portion 102 may define at least one aperture 114 configured to selectively provide fluid communication between the internal cavity 112 and an external environment 116. For example, the aperture 114 may be used to selectively vent in air from the atmosphere to relieve a vacuum within the cavity. In one embodiment, there may be a plurality of apertures (e.g., two, three, or more).

A filter 118 may be positioned in the internal cavity 112. The filter 118 may be configured to divide the internal cavity 112 into a filter chamber 120 and a flow chamber 122. The filter chamber 120 may be defined by a first portion 102a of the body portion 102, and the flow chamber 122 may be defined by a second portion 102b of the body portion. In some embodiments, as illustrated, the filter chamber 120 may extend perpendicularly from the flow chamber 122. Therefore, for example, the body portion 102 may be T-shaped. As further illustrated, in one embodiment the inlet 104, flow chamber 122, and outlet 106 may be oriented coaxially. In other embodiments, the filter chamber may be located on the top surface of a curved body portion defining a curved flow chamber (e.g., the body portion may define a flow chamber with an inverted U-shape with the filter chamber extending upwardly therefrom) configured to be positioned at the highest point of a drain loop. This curved configuration may be similar to the embodiment of the siphon break apparatus illustrated in FIG. 2 except the body portion 102 would curve downwardly. A curved configuration may reduce the potential for kinking, reduction in internal cross-sectional area, and stress on the drain hose 30 (or other conduit) by reducing or eliminating the need to bend the conduit. In these configurations flow through the siphon break apparatus 100 may occur in a relatively unimpeded manner. The filter 118 may define a filter surface (a backside of which is indicated by reference numeral 124) configured to filter fluid flowing through the siphon prevention apparatus 100 and substantially prevent solids (e.g., food particles) from entering the filter chamber 120. Thereby, the filter 118 may prevent the solids from blocking the aperture 114.

The filter surface 124 may be oriented substantially perpendicularly to a major axis 126 of the flow chamber 122. The flow chamber 122 may define a cross-sectional area substantially perpendicular to the major axis 126 of the flow chamber and may be greater than a filter area defined by the orifices 128. Further, the filter 118 may define a plurality of orifices 128. The orifices 128 may extend substantially perpendicularly to the major axis 126 of the flow chamber 122. The filter 118 may comprise a screen, mesh, or a wall with one or more of the orifices 128 defined therein, although various other embodiments of filters may be employed in other embodiments. As will be described below, use of the filter 118 with the orifices 128 defining a filter area that is less than the cross-sectional area of the flow chamber 122 may discourage buildup of solids in the orifices.

In some embodiments the flow chamber 122 may define one or more curved portions 129 that position the filter chamber 120 such that the filter 118 is nearer the center of the flow chamber. Thereby, the filter 118 may be subjected to relatively faster flow toward the center of the flow chamber 122 such that any solids collecting on the filter will be subjected to relatively higher shear forces than would be the case if the filter was positioned further from the center of the flow channel. Further, the curved portions 129 may permit the siphon break apparatus 100 to be formed in a relatively more compact manner whereby the filter chamber 120 extends from the flow chamber 122 a relatively smaller distance. Additionally, use of the curved portions 129 allows the filter 118 to be relatively flat in some embodiments, which may facilitate manufacture of the orifices 128 in the filter.

The aperture 114 may be defined in the body portion 102 at the filter chamber 120 so as to selectively provide for fluid communication therewith. For example, in one embodiment the body portion 102 may comprise a filter chamber cap 130 that may at least partially define the filter chamber 120 and the aperture 114 may be defined in the filter chamber cap 130. The filter chamber cap 130 may be integral with the remainder of the body portion 102 in some embodiments, whereas in other embodiments the filter chamber cap may be removable from, or otherwise permanently attached to, the body portion. For example, the filter chamber cap 130 may secure to the remainder of the body portion 102 via interference fit, welded connection, snap-fit with O-ring or other seal, threaded connection, etc. In embodiments of the siphon break apparatus 100 in which the filter chamber cap 130 is removable, assembly and maintenance of the siphon break apparatus 100 may be facilitated, for example, by providing for access to the filter chamber 120 and components of the siphon break apparatus contained therein.

As illustrated in FIG. 3, the siphon break apparatus 100 may further comprise an umbrella valve 132. The umbrella valve 132 may be connected to the body portion 102, for example, at the filter chamber cap 130. Further, the umbrella valve 132 may be at least partially received in the filter chamber 120. In this regard, the filter chamber cap 130 may be spaced from the filter 118 and the flow chamber 122, and thereby the aperture 114 and the umbrella valve 132 may also be spaced from the filter and the flow chamber. Accordingly, the umbrella valve 132 may have adequate space to avoid contact with the filter 118. Further, the umbrella valve 132 may be sufficiently spaced from the flow chamber 122 so as to avoid issues with the flow through the flow chamber damaging the umbrella valve or preventing sealing of the aperture 114. Additionally, the space between the filter 118 and the filter chamber cap 130 may cause air to be trapped between any fluid entering the filter chamber 120 and the filter chamber cap. When configured in this manner, the presence of the air prevents or reduces flow into the filter chamber 120, which may reduce the likelihood of filter clogging. This configuration may also provide a still fluid to pressurize the umbrella valve so that the edges are pressed closed which may discourage leakage of the fluid through the aperture 114.

In one embodiment the umbrella valve 132 may comprise a domed closure 134 and a stem 136. The stem 136 may position, mount, and/or preload the domed closure 134 of the umbrella valve 132. In one embodiment the stem 136 may couple to the domed closure 134 in the filter chamber 120 and extend through the filter chamber cap 130 to the external environment 116. Further, the umbrella valve 132 may be oriented such that the stem 136 is oriented substantially perpendicular to the major axis 126 of the flow chamber 122.

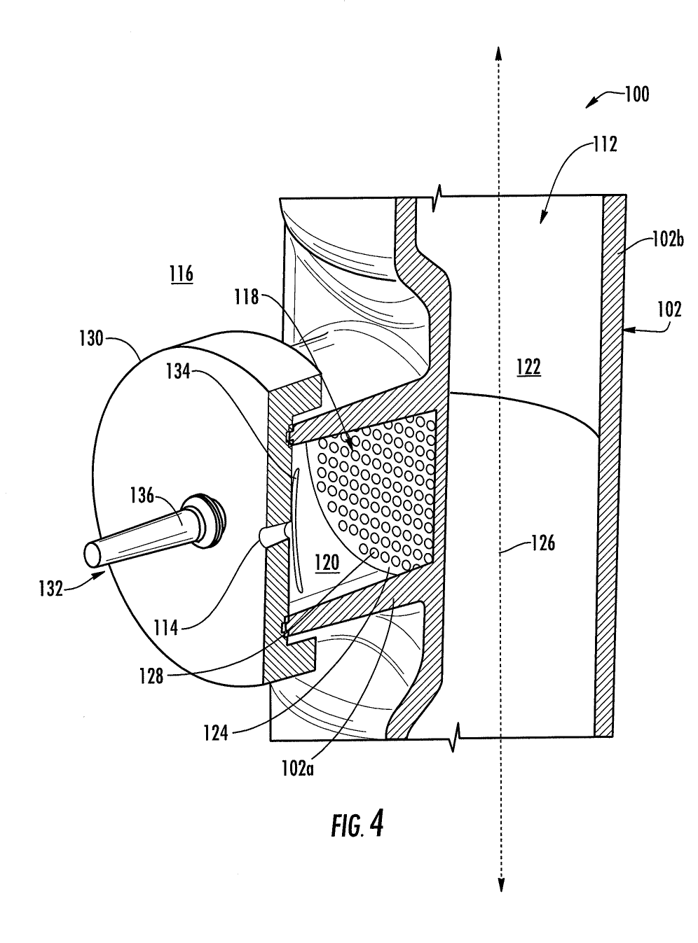

The domed closure 134 of the umbrella valve 132 may define a flexible material such as rubber in some embodiments. Thereby the domed closure 134 may be configurable between a first position wherein the dome substantially seals shut the aperture 114 (see, e.g., FIG. 3), and a second position wherein the domed closure at least partially unseals the aperture so as to provide fluid communication between the internal cavity 112 and the external environment 116 (see, e.g., FIG. 4). In some embodiments the domed closure 134 may be biased to the first closed position wherein the domed closure substantially seals the aperture 114 closed. For example, the domed closure 134 may be biased to form a concave shape directed toward the filter chamber cap 130 that seals shut the aperture 114.

In this regard, FIG. 3 illustrates the siphon break apparatus 100 in an initial closed state. The domed closure 134 of the umbrella valve 132 may seal shut the aperture 114 during instances in which there is no flow through the siphon break apparatus 100 and in instances in which fluid is being pumped through the siphon break apparatus. For example, fluid may be pumped through the siphon break apparatus 100 during the drain cycle of the dishwasher 10 by the drain pump 26, as discussed above.

When fluid is pumped through the siphon break apparatus 100, the fluid may enter the flow chamber 122 through the inlet 104. Accordingly, the fluid may partially or entirely fill the flow chamber 122 as the fluid travels therethrough prior to exiting the siphon flow apparatus 100 through the outlet 106. As the fluid travels through the flow chamber 122 a portion of the fluid may enter the filter chamber 120. However, the filter 118 may prevent solids from traveling into the filter chamber 120.

Accordingly, the filter 118 may substantially prevent solids from coming into contact with the umbrella valve 132. In this regard, the filter 118 may prevent the solids from being trapped between the domed closure 134 and the filter chamber cap 130, which might prevent the umbrella valve 132 from fully sealing shut the aperture 114. Further, as noted, above, the umbrella valve 132 may be configured such that the domed closure 134 is biased to seal shut the aperture 114. In this regard, the umbrella valve 132 may be considered a normally-closed check valve. By biasing the domed closure 134 against the filter chamber cap 130, the possibility for solids to lodge between the domed closure and the filter chamber cap is further reduced. Also, since the domed closure 134 is biased to be in contact with the filter chamber cap 130, the aperture 114 is shut at the time the drain pump 26 begins pumping such that issues with the umbrella valve 132 sealing fast enough to prevent leakage, an issue with some types of check valves, may be avoided. Additionally, by placing the domed closure 134 inside the filter chamber 120, an increase in pressure within the internal cavity 112 as fluid is pumped through the siphon break apparatus 100 may cause the domed closure 134 to seal more tightly against the filter chamber cap 130. Further, by placing the domed closure 134 inside the filter chamber 120, the domed closure may not be directly exposed to flow through the flow chamber 122, which might otherwise break the seal and/or damage the domed closure.

Accordingly, the umbrella valve 132 may be configured to substantially seal the aperture 114 closed. Thereby, as indicated by arrow 138, fluid that travels through the filter 118 may be substantially prevented from exiting the filter chamber 120 through the aperture, or plurality of apertures, 114. Thus, the siphon break apparatus 100 may function to prevent leakage of the fluid and deliver the fluid from the first portion 30A of the drain hose 30 to the second portion 30B of the drain hose when the drain pump 26 is pumping fluid from the dishwasher 10.

However, the siphon break apparatus 100 may also be configured to prevent the siphon effect when the drain pump 26 stops pumping the fluid. In this regard, FIG. 4 illustrates an enlarged sectional view through the siphon break apparatus 100 when the domed closure 134 of the umbrella valve 132 is at least partially unsealed from the aperture 114. The domed closure 134 may be moved partially or fully out of contact with the filter chamber cap 130 as a result of a pressure differential forming between the external environment 116 and the internal cavity 112.

In particular, in terms of the previously described dishwasher 10, after the drain pump 26 quits pumping the fluid, a reduced pressure region may form in the drain hose 30 near a top portion thereof as a result of gravity acting to pull the fluid downward. Reverse flow in the first portion of drain hose 30A may be prevented in dishwashers by the check valve at the drain pump discharge. Flow through the second portion 30B of the drain hose 30 is unrestricted. Atmospheric pressure within the dishwasher may thereby push fluid up the first portion 30A of the drain hose 30 into the reduced pressure region at the top of the drain hose and on through the second portion of drain hose 30B to the home's drain system.

The siphon break apparatus 100 may be connected to the drain hose 30 in the reduced pressure region at or near the top of the drain hose, for example as illustrated in FIG. 2. Thereby, pressure in the external environment 116 (e.g., atmospheric pressure) may be greater than the reduced pressure in the internal cavity 112 of the siphon break apparatus 100. Accordingly, the relatively greater pressure of the external environment 116 may act upon the domed closure 134, forcing the domed closure at least partially out of contact with the filter chamber cap 130. Accordingly, fluid communication may be established between the internal cavity 112 of the siphon break apparatus 100 and the external environment through the aperture 114. For example, air may flow through the aperture 114 into the filter chamber 120 and the flow chamber 122 so as to relieve a low pressure region. Accordingly, the pressure differential between the external environment 116 and the internal cavity 112 of the siphon break apparatus 100 may be reduced or eliminated and accordingly the siphon effect may be prevented. Once the pressure substantially equalizes, the domed closure 134 may return to the original closed position, as illustrated in FIG. 3.

Further, the filter 118 may be cleaned each time the domed closure 134 releases from the filter chamber cap 130 and allows air into the filter chamber 120. In this regard, as air flows through the filter 118, the air (and any liquid that may have entered the filter chamber 120) may tend to dislodge solids that may have accumulated on the filter. For example, solids stuck in the orifices 128 of the filter 118 may be pushed out of the orifices by the flow of air (and any liquid accumulated in the filter chamber) and into the flow chamber 122. As noted above, in some embodiments, the flow chamber 122 may define a cross-sectional area substantially perpendicular to the major axis 126 of the flow chamber that is greater than a filter area defined by the orifices 128 of the filter 118. In this regard, by employing orifices 128 that define a filter area that is relatively small, the air flowing through the filter chamber 120 may be constricted, and hence the air may be directed through the filter 118 at a relatively high velocity. Accordingly, solids accumulating in the orifices 128 of the filter 118 may be blown therefrom by air entering the filter chamber 120 as the umbrella valve 132 opens to prevent the siphon effect. Further, the filter 118 may be positioned such that the filter surface 124 oriented substantially perpendicularly to the major axis 126 of the flow chamber 122. This arrangement may cause drain flow across the filter surface 124 to occur substantially tangentially, which may further assist in preventing buildup of solids thereon, particularly when the filter is positioned nearer the center of the flow chamber 122, as described above. Accordingly, the siphon prevention apparatus 100 may include one or more features configured to prevent and/or reduce the buildup of solids on the filter 118.

As illustrated in FIG. 4, the domed closure 134 may be configured to remain inside the filter chamber 120 in both the first position (wherein the domed closure seals shut the aperture, or plurality of apertures, 114) and the second position (wherein the domed closure unseals from the filter chamber cap 134 to enable air flow through the aperture, or plurality of apertures). In this regard, by retaining the domed closure 134 inside the filter chamber 120, the domed closure may avoid direct exposure to flow of the fluid through the flow chamber 122. Accordingly, the potential for damage to the domed closure 134 may be reduced.

The orientation of the siphon break apparatus 100 may differ in various embodiments. In this regard, the siphon break apparatus 100 is illustrated in FIG. 2 with the body portion 102 configured such that the major axis of the flow chamber 122 is oriented substantially horizontally. In this orientation the filter chamber 120 may be positioned above the flow chamber 122. Positioning the filter chamber 120 above the flow chamber 122 may assist in preventing the siphon effect. In this regard, the force of gravity may cause any fluid collected in the filter chamber 120 to exit therefrom after the fluid is no longer pumped, which may create a low pressure in the filter chamber that encourages the umbrella valve 132 to open. Note that the orifices 128 may be positioned such that fluid may drain from the filter chamber 120 in the various orientations disclosed herein (e.g., in one embodiment the orifices may extend across the entire surface of the filter 118 to accommodate all the orientations). Further, the direction and momentum of the fluid flowing through the flow chamber 122, which may define a substantially straight flow path, may generally discourage the fluid from directly impinging on the umbrella valve 132. Thereby, for example, leakage of the fluid through the aperture 114 may be avoided.

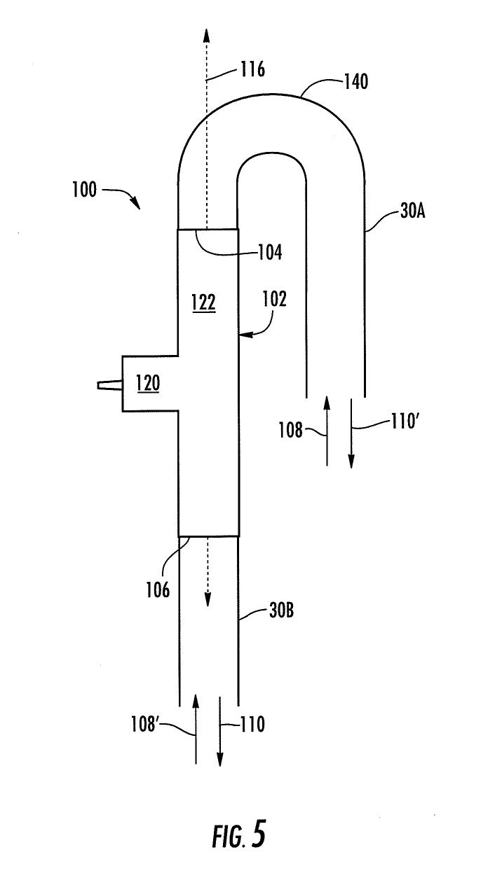

In another embodiment the body portion 102 may be configured such that the major axis 126 of the flow chamber 122 is oriented substantially vertically. For example, the siphon break apparatus 100 may be positioned downstream of an upper bend 140 in the drain hose 30 in terms of the fluid flow direction therethrough, as illustrated in FIG. 5. Alternatively, the siphon break apparatus 100 may be positioned upstream of the upper bend 140 in the drain hose 30 in terms of the fluid flow direction therethrough. For example, this alternate configuration is illustrated by arrows 108′, 110′, which show a flow configuration in the opposite direction. Various other orientations and configurations of the siphon break apparatus 100 may also be possible in other embodiments. As discussed above, the direction and momentum of the fluid flowing through the flow chamber 122, which may define a substantially straight flow path, may generally discourage the fluid from directly impinging on the umbrella valve 132, regardless of orientation.

The siphon break apparatus may connect to the drain hose (or other conduit) via a variety of configurations. In this regard, in the illustrated embodiments the fluid in the drain hose 30 flows through the flow chamber 122 defined in the siphon break apparatus 100. However, in other embodiments, the siphon break may not include a flow chamber through which fluid flows. For example, the flow chamber could be eliminated and the body portion of the siphon break apparatus could couple to an opening in a conduit (e.g., through threaded fitting or chemical welding, etc.) such that the siphon effect is prevented. Accordingly, the siphon break apparatus need not define a part of the normal flow path through the conduit in some embodiments.

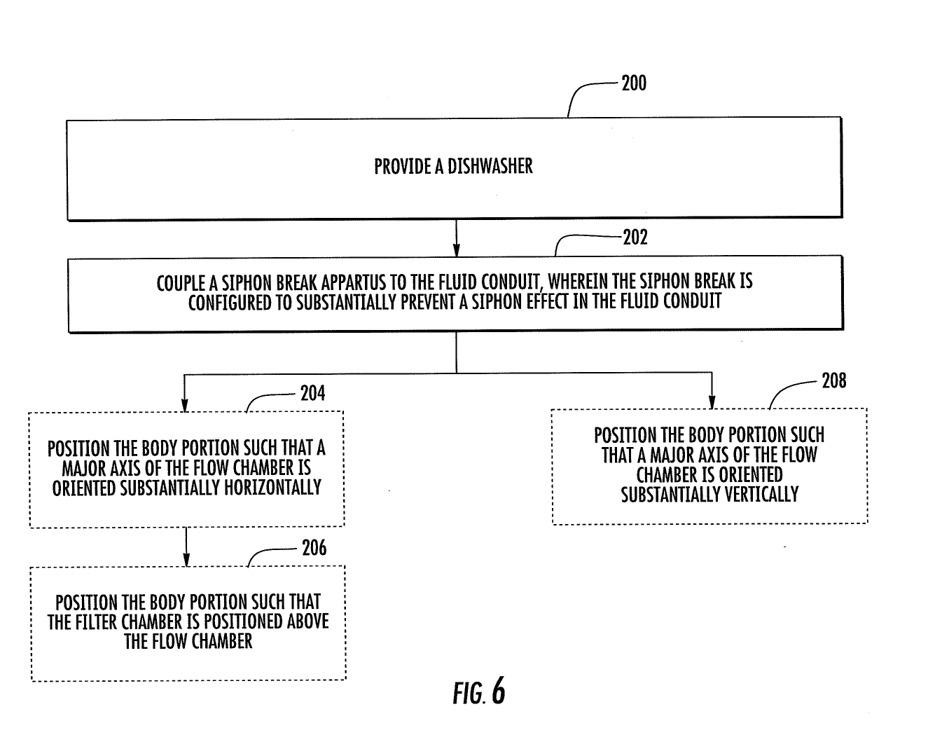

In a further embodiment a method for assembling a dishwasher is provided. As illustrated in FIG. 6, the method may include steps such as providing a dishwasher at operation 200. The dishwasher may comprise the above described dishwasher 10 in some embodiments. However, various other dishwashers and washing appliance may be employed in other embodiments. Further, the method may include coupling a siphon break apparatus to the fluid conduit, wherein the siphon break is configured to substantially prevent a siphon effect in the fluid conduit at operation 202. The siphon break apparatus may comprise the above-described siphon break apparatus 100 in some embodiments, although various other siphon break apparatuses may be employed in other embodiments.

In some embodiments, certain ones of the above-described operations (as illustrated in solid lines in FIG. 6) may be modified or additional operations may also be included (some examples of which are shown in dashed lines in FIG. 6). Also, in some embodiments the filter may be configured to divide the internal cavity into the filter chamber and a flow chamber, and the flow chamber may be configured to receive a fluid flowing through the fluid conduit. Thus, for example, the method may further comprise the step of positioning the body portion such that a major axis of the flow chamber is oriented substantially horizontally at operation 204. Additionally, the method may include the step of positioning the body portion such that the filter chamber is positioned above the flow chamber at operation 206. In this regard, FIG. 2 illustrates the above-described siphon break apparatus 100 oriented in a horizontal position with the filter chamber 120 positioned above the flow chamber 122. In an alternate embodiment the method may include the step of positioning the body portion such that a major axis of the flow chamber is oriented substantially vertically at operation 208. For example, FIG. 5 illustrates the above-describe siphon break apparatus 100 oriented vertically. However, the siphon break apparatus 100 may also be positioned in a variety of configurations other than vertical or horizontal.

Accordingly, embodiments of the siphon break apparatus and methods related thereto may provide advantages. For example, the filter may prevent solids such as food particles from impeding operation of the umbrella valve. Further, the umbrella valve may be biased closed. Therefore, the siphon break apparatus may maintain a substantially tight seal that may prevent leakage when fluid is pumped through the siphon break apparatus, and the seat area around the aperture may be remain clean. Unlike a rising, floating check ball, the siphon break apparatus disclosed herein does not rely on a potentially dirty fluid to force the valve closed and the valve may not suffer from the possibility that some of the flow will escape before the valve reaches a closed position, since it is biased closed. The sealing face of the domed closure is not exposed to the stream of fluid flowing through the conduit due to the valve being biased closed and positioned in the valve chamber. Also, by positioning the domed closure inside the internal cavity, pressure in the internal cavity during draining through the drain hose may make the seal formed by the domed closure more secure. Further, the siphon break apparatus may be installed in multiple positions. For example, the filter chamber may be positioned above the flow chamber. Alternatively, the flow chamber may be positioned substantially vertically. Accordingly, the siphon break apparatus may be useable in a variety of configurations, which increase the usability of the siphon break apparatus with different embodiments of dishwashers and other appliances and various types of installations thereof.

Many modifications and other embodiments will come to mind to one skilled in the art having the benefit of the teachings presented in the foregoing descriptions and the associated drawings. Therefore, it is to be understood that the embodiments are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A siphon break apparatus configured to substantially prevent a siphon effect in a fluid conduit, the siphon break apparatus comprising:
a body portion configured to connect to the fluid conduit, the body portion defining:
an internal cavity; and
at least one aperture configured to selectively provide fluid communication between the internal cavity and an external environment;
a filter coupled to the body portion so as to define a filter chamber in the internal cavity, the aperture configured to selectively provide for fluid communication with the filter chamber; and
an umbrella valve connected to the body portion and at least partially received in the filter chamber, the umbrella valve comprising a domed closure configurable between:
a first position wherein the domed closure substantially seals the aperture closed, and
a second position wherein the domed closure at least partially unseals the aperture so as to provide fluid communication between the internal cavity and the external environment and thereby substantially prevents the siphon effect in the fluid conduit.

2. The siphon break apparatus of claim 1, wherein the filter is configured to divide the internal cavity into the filter chamber and a flow chamber, and
wherein the flow chamber is configured to receive a fluid flowing through the fluid conduit.

3. The siphon break apparatus of claim 2, wherein the umbrella valve further comprises a stem, wherein the stem extends from the filter chamber to the external environment.

4. The siphon break apparatus of claim 2, wherein the filter defines a filter surface, and
wherein the filter surface is oriented substantially perpendicularly to a major axis of the flow chamber such that fluid flow through the flow chamber is tangential to the filter surface.

5. The siphon break apparatus of claim 2, wherein the filter defines a plurality of orifices that extend substantially perpendicularly to a major axis of the flow chamber.

6. The siphon break apparatus of claim 2, wherein the body portion defines an inlet and an outlet, and
wherein the inlet, the flow chamber, and outlet are disposed coaxially to one another.

7. The siphon break apparatus of claim 2, wherein the filter comprises a plurality of orifices defining a filter area,
wherein the flow chamber defines a cross-sectional area substantially perpendicular to a major axis of the flow chamber, and
wherein the filter area is less than the cross-sectional area of the flow chamber.

8. The siphon break apparatus of claim 2, wherein the domed closure is biased to the first position such that the domed closure is initially closed when fluid flows through the flow chamber.

9. The siphon break apparatus of claim 2, wherein the aperture is spaced away from the filter and the flow chamber.

10. The siphon break apparatus of claim 2, wherein the umbrella valve is configured to unseal from the aperture in the second position and allow air from the external environment to enter the filter chamber, travel through the filter and into the flow chamber so as to relieve a low pressure region and substantially prevent the siphon effect in the fluid conduit.

11. The siphon break apparatus of claim 2, wherein the filter chamber extends perpendicularly from the flow chamber.

12. The siphon break apparatus of claim 11, wherein the body portion is T-shaped.

13. The siphon break apparatus of claim 11, wherein the filter chamber is positioned above the flow chamber.

14. The siphon break apparatus of claim 2, wherein the flow chamber defines a curved configuration.

15. The siphon break apparatus of claim 14, wherein the flow chamber defines an inverted U-shape.

16. The siphon break apparatus of claim 1, wherein the umbrella valve further comprises a stem, wherein the stem extends from the filter chamber to the external environment.

17. The siphon break apparatus of claim 1, wherein the body portion comprises a filter chamber cap at least partially defining the filter chamber.

18. The siphon break apparatus of claim 17, wherein the aperture is defined in the filter chamber cap.

19. The siphon break apparatus of claim 17, wherein the filter chamber cap is removably attached to the body portion.

20. The siphon break apparatus of claim 17, wherein the filter chamber cap is permanently attached to the body portion.

21. The siphon break apparatus of claim 1, wherein the domed closure is configured to remain inside the filter chamber in both the first position and the second position.

22. A dishwasher, comprising:
a washing chamber;
a fluid supply configured to supply a fluid to the washing chamber;
a drain pump configured to pump the fluid through a fluid conduit configured to drain the fluid from the washing chamber; and
a siphon break apparatus coupled to the fluid conduit and configured to substantially prevent a siphon effect in the fluid conduit, the siphon break apparatus comprising:
a body portion configured to connect to the fluid conduit, the body portion defining:
an internal cavity; and
at least one aperture configured to selectively provide fluid communication between the internal cavity and an external environment;
a filter coupled to the body portion so as to define a filter chamber in the internal cavity, the aperture configured to selectively provide for fluid communication with the filter chamber; and
an umbrella valve connected to the body portion and at least partially received in the filter chamber, the umbrella valve comprising a domed closure configurable between:
a first position wherein the domed closure substantially seals the aperture closed, and
a second position wherein the domed closure at least partially unseals the aperture so as to provide fluid communication between the internal cavity and the external environment and thereby substantially prevents the siphon effect in the fluid conduit.

23. The dishwasher of claim 22, wherein the filter is configured to divide the internal cavity into the filter chamber and a flow chamber, and
wherein the flow chamber is configured to receive a fluid flowing through the fluid conduit.

24. The dishwasher of claim 23, wherein the body portion is configured such that a major axis of the flow chamber is oriented substantially horizontally.

25. The dishwasher of claim 24, wherein the filter chamber is positioned above the flow chamber.

26. The dishwasher of claim 23, wherein the body portion is positioned such that a major axis of the flow chamber is oriented substantially vertically.

27. A method for assembling a dishwasher, comprising the steps of:
providing a dishwasher, comprising:
a washing chamber;
a fluid supply configured to supply a fluid to the washing chamber; and
a drain pump configured to receive the fluid and pump the fluid through a fluid conduit configured to drain the fluid from the washing chamber; and
coupling a siphon break apparatus to the fluid conduit, wherein the siphon break is configured to substantially prevent a siphon effect in the fluid conduit, the siphon break apparatus comprising:
a body portion configured to connect to the fluid conduit, the body portion defining:
an internal cavity; and
at least one aperture configured to selectively provide fluid communication between the internal cavity and an external environment;
a filter coupled to the body portion so as to define a filter chamber in the internal cavity, the aperture configured to selectively provide for fluid communication with the filter chamber; and
an umbrella valve connected to the body portion and at least partially received in the filter chamber, the umbrella valve comprising a domed closure configurable between:
a first position wherein the domed closure substantially seals the aperture closed, and
a second position wherein the domed closure at least partially unseals the aperture so as to provide fluid communication between the internal cavity and the external environment and thereby substantially prevents the siphon effect in the fluid conduit.

28. The method of claim 27, wherein the filter is configured to divide the internal cavity into the filter chamber and a flow chamber, and
wherein the flow chamber is configured to receive a fluid flowing through the fluid conduit.

29. The method of claim 28, further comprising the step of positioning the body portion such that a major axis of the flow chamber is oriented substantially horizontally.

30. The method of claim 29, further comprising the step of positioning the body portion such that the filter chamber is positioned above the flow chamber.

31. The method of claim 28, further comprising the step of positioning the body portion such that a major axis of the flow chamber is oriented substantially vertically.
